(19) United States
(12) Patent Application Publication
(10) Pub. No.: US 2026/0008346 A1
(43) Pub. Date: Jan. 8, 2026

(54) APPARATUS AND METHOD FOR MANAGING POWER FOR VEHICLE

(71) Applicants: HYUNDAI MOTOR COMPANY, SEOUL (KR); KIA CORPORATION, SEOUL (KR); EGTRONICS CO., LTD., HWASEONG-SI (KR)

(72) Inventors: Geun Ok SIN, Hwaseong-si (KR); Soon Cheol HWANG, Hwaseong-si (KR); Yoon Kyu SHIN, Osan-si (KR); Ji Hyeong LEE, Hwaseong-si (KR); Eun Jin JUNG, Seongnam-si (KR); Chan Ho KANG, Suwon-si (KR); Meong Kyu CHOI, Yongin-si (KR)

(21) Appl. No.: 18/970,891

(22) Filed: Dec. 5, 2024

(30) Foreign Application Priority Data
Jul. 5, 2024 (KR) 10-2024-0089127

(51) Int. Cl. B60L 3/00; B60L 58/13; B60L 58/20; B60L 58/22

(52) U.S. Cl. CPC B60L 3/0046; B60L 3/0092; B60L 58/13; B60L 58/20; B60L 58/22; B60L 2210/12; B60L 2210/14; B60L 2260/32

(57) ABSTRACT

A power-managing apparatus for a vehicle includes a first power supplier configured to supply power, a first voltage system including a first battery configured to step down a voltage output from the first power supplier into a first voltage to supply the first voltage to a first load, and supply a first redundancy power to the first load when the voltage output from the first power supplier is not transmitted; a second voltage system including a second battery configured to step down a voltage output from the first power supplier into a second voltage to supply the second voltage to a second load, and supply a second redundancy power to the second load when the voltage output from the first power supplier is not transmitted; and a power conversion controller configured to convert the first voltage into the second voltage and convert the second voltage into the first voltage.

### CROSS-REFERENCE TO RELATED APPLICATIONS

The present application claims priority to Korean Patent Application No. 10-2024-0089127, filed on Jul. 5, 2024, the entire contents of which is incorporated herein for all purposes by this reference.

### TECHNICAL FIELD

The present disclosure relates to an apparatus and a method for managing power for a vehicle.

### BACKGROUND

A vehicle may include a low-voltage power supply system that supplies power to electrical loads through a low-voltage DC/DC converter (LDC) that steps down a voltage from a high-voltage battery. In particular, a vehicle including an autonomous driving system realizes a power redundancy technology by including a plurality independent low-voltage power supply systems to supply power of one high-voltage battery to conventional electrical loads and respective electrical loads for autonomous driving, thereby preventing safety accidents in case of a power supply failure. For example, the vehicle may include a plurality of LDCs to supply power of the high-voltage battery to the conventional electrical loads and the electrical loads for autonomous driving.

Since a conventional method for realizing power redundancy simply adopts a method of connecting a secondary power by detecting whether a short circuit occurs, there are limitations to this method.

### SUMMARY

The present disclosure provides an apparatus and a method for managing power for a vehicle, which are capable of increasing a degree of using secondary power and improving stability of a redundancy power net in an autonomous driving vehicle having a power redundancy structure.

Technical objects to be solved by the present disclosure are not limited to the aforementioned technical objects and unmentioned technical objects will be clearly understood by those skilled in the art from the specification and the appended claims.

An embodiment of the present disclosure provides an apparatus for managing power for a vehicle, the apparatus comprising: a first power supplier configured to supply power, a first voltage system configured to step down a voltage output from the first power supplier into a first voltage to supply the first voltage to one or more first loads, the first voltage system comprising a first battery configured to supply a first redundancy power to the one or more first loads, a second voltage system configured to step down the voltage output from the first power supplier into a second voltage, which is less in magnitude than the first voltage, to supply the second voltage to one or more second loads, the second voltage system comprising a second battery configured to supply a second redundancy power to the one or more second loads, and a power conversion controller configured to convert the first voltage of the first voltage system into the second voltage and convert the second voltage of the second voltage system into the first voltage, wherein the first battery and the second battery are charged by receiving power from the power conversion controller while the vehicle is in autonomous driving.

In an embodiment, the first voltage system may include a first converter configured to step down the voltage output from the first power supplier into the first voltage, and a first controller configured to supply the first voltage to the one or more first loads and charge the first battery by a charging voltage of a first voltage level from the power conversion controller when a state of charge (SOC) of the first battery is equal to or less than a reference value while the first voltage being supplied to the one or more first loads.

In an embodiment, the first controller may control the first battery to supply the first redundancy power to the first load when the first converter is in a failed state.

In an embodiment, the first controller may supply the first voltage to the power conversion controller according to a request from the second voltage system while the first voltage being supplied to the one or more first loads.

In an embodiment, the second voltage system may include: a second converter configured to step down the voltage output from the first power supplier into the second voltage, and a second controller configured to supply the second voltage to the one or more second loads and charge the second battery by a charging voltage of a second voltage level from the power conversion controller when a SOC of the second battery is equal to or less than a reference value while the second voltage being supplied to the one or more second loads.

In an embodiment, the second controller may control the second battery to supply the second redundancy power to the one or more second loads when the second converter is in a failed state.

In an embodiment, the second controller may supply the second voltage to the power conversion controller according to a request from the first voltage system while the second voltage being supplied to the second load.

In an embodiment, the one or more first loads or the one or more second loads may comprise at least one autonomous driving load.

In an embodiment, the first voltage system or the second voltage system is further configured to balance SOC levels of the first battery and the second battery after autonomous driving.

In an embodiment, the first voltage system may include a first converter configured to step down the voltage output from the first power supplier into the first voltage, and a first controller configured to supply, during the autonomous driving, the first voltage to the one or more first loads and charge, after the autonomous driving, the first battery by a charging voltage of a first voltage level from the power conversion controller when the SOC level of the second battery is greater than the SOC level of the first battery.

In an embodiment, the first controller may supply power from the first battery to the power conversion controller when the SOC level of the second battery is less than the SOC level of the first battery.

In an embodiment, the second voltage system may include a second converter configured to step down the voltage output from the first power supplier into the second voltage, and a second controller configured to supply, during the autonomous driving, the second voltage to the one or more second loads and charge, after the autonomous driving, the second battery by a charging voltage of a second voltage level from the power conversion controller when the SOC level of the first battery is greater than the SOC level of the second battery.

In an embodiment, the second controller may supply power from the second battery to the power conversion controller when the SOC level of the first battery is less than the SOC level of the second battery.

In an embodiment of the present disclosure, there is provided a method of controlling an apparatus for managing power for a vehicle, the method comprising preparing a first voltage system configured to step down a voltage output from the first power supplier into a first voltage to supply the first voltage to one or more first loads, the first voltage system comprising a first battery configured to supply a first redundancy power to the one or more first loads, preparing a second voltage system configured to step down the voltage output from the first power supplier into a second voltage, which is less in magnitude than the first voltage, to supply the second voltage to one or more second loads, the second voltage system comprising a second battery configured to supply a second redundancy power to the one or more second loads, checking a state of charge (SOC) of the first battery and a SOC of the second battery during autonomous driving; charging the first battery by a charging voltage from the second voltage system when the SOC of the first battery is equal to or less than a first reference value, and charging the second battery by a charging voltage from the first voltage system when the SOC of the second battery is equal to or less than a second reference value.

In an embodiment, the first voltage system may include a first converter configured to step down the voltage output from the first power supplier into the first voltage, and a first controller configured to supply the first voltage to the one or more first loads and charge the first battery by a charging voltage of a first voltage level from the power conversion controller when the SOC of the first battery is equal to or less than the first reference value.

In an embodiment, the second voltage system may include a second converter configured to step down the voltage output from the first power supplier into the second voltage, and a second controller configured to supply the second voltage to the one or more second loads and charge the second battery by a charging voltage of a second voltage level from the power conversion controller when the SOC of the second battery is equal to or less than the second reference value while the second voltage being supplied to the second load.

In an embodiment, the method may further include balancing SOC levels of the first battery and the second battery after autonomous driving.

In an embodiment, the first voltage system may include a first converter configured to step down the voltage output from the first power supplier into the first voltage; and a first controller configured to supply, during the autonomous driving, the first voltage to the one or more first loads and charge, after the autonomous driving, the first battery by a charging voltage of a first voltage level from the first voltage system when the SOC of the second battery is greater than the SOC of the first battery and supply power of the first battery to the second voltage system when the SOC of the second battery is less than the SOC of the first battery.

In an embodiment, the second voltage system may include a second converter configured to step down the voltage output from the first power supplier into the second voltage, and a second controller configured to supply, during autonomous driving, the second voltage to the one or more second loads and charge, after the autonomous driving, the second battery by a charging voltage of a second voltage level from the first voltage system when the SOC of the first battery is greater than the SOC of the second battery and supply power of the second battery to the first voltage system when the SOC of the first battery is less than the SOC of the second battery.

According to an embodiment of the present disclosure, there is provided a non-transitory recording medium storing instructions which are executed by one or more processors, wherein the instructions, when executed by the one or more processors, cause the one or more processors to prepare a first voltage system configured to step down a voltage output from the first power supplier into a first voltage to supply the first voltage to one or more first loads, the first voltage system comprising a first battery configured to supply a first redundancy power to the one or more first loads, prepare a second voltage system configured to step down the voltage output from the first power supplier into a second voltage, which is less in magnitude than the first voltage, to supply the second voltage to one or more second loads, the second voltage system comprising a second battery configured to supply a second redundancy power to the one or more second loads, check a state of charge (SOC) of the first battery and a SOC of the second battery during autonomous driving; charge the first battery by a charging voltage from the second voltage system when the SOC of the first battery is equal to or less than a first reference value; and charge the second battery by a charging voltage from the first voltage system when the SOC of the second battery is equal to or less than a second reference value.

### BRIEF DESCRIPTION OF THE DRAWINGS

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, the same reference numerals refer to the same or equivalent parts of the present disclosure throughout the several figures of the drawing.

FIG. 1 is a block diagram illustrating an apparatus for managing power for a vehicle and load control according to an embodiment of the present disclosure.

FIG. 2 is a schematic diagram illustrating a power connection state of the apparatus for managing power for a vehicle according to an embodiment of the present specification.

FIG. 3 is a schematic diagram illustrating a configuration of the apparatus for managing power for a vehicle according to an embodiment of the present disclosure.

FIG. 4 is a flowchart illustrating a method for managing power for a vehicle according to an embodiment of the present disclosure.

FIG. 5 is a schematic diagram illustrating a flow of power of an apparatus for managing power for a vehicle according to a first embodiment of the present specification.

FIG. 6 is a schematic diagram illustrating a flow of power of an apparatus for managing power for a vehicle according to a second embodiment of the present disclosure.

### DETAILED DESCRIPTION

Hereinafter, embodiments will be described to explain the present disclosure in detail, and the present disclosure will be described in detail with reference to the accompanying drawings for understanding the invention. The present disclosure may, however, be embodied in different forms and should not be constructed as limited to the embodiments set forth herein. Rather, these embodiments are provided so that this disclosure will be thorough and complete, and will fully convey the scope of the present disclosure to those skilled in the art.

In the description of the embodiments, when it is stated that an element is formed “on or under” another element, the terms “on or under” include both cases where the two elements are directly in contact with each other and where one or more other elements are interposed between the two elements.

Also, when the terms “on” or “under” are used, they may include not only the upward direction relative to one element but also the downward direction.

Also, relational terms such as “first” and “second,” “upper/on” and “lower/under,” and the like, used below, do not necessarily require or imply any specific physical or logical relationship or order between such entities or elements, but may simply be used to distinguish one entity or element from another.

Furthermore, when it is described that one comprises (or includes or has) some elements, it should be understood that it may comprise (or include or has) only those elements, or it may comprise (or include or have) other elements as well as those elements when there is no specific limitation. In the following description of the present disclosure, a detailed description of known functions and configurations incorporated herein will be omitted to avoid making the subject matter of the present disclosure unclear and, in every possible case, like reference numerals are used for referring to the same or similar elements in the description and drawings.

According to an embodiment of the present specification, in a power management device with a redundant power network for a plurality of low-voltage power supply systems, the state of charge (SOC) of each battery in the low-voltage power supply systems is monitored during autonomous driving to ensure preemptive charging. After the autonomous driving ends, the SOC of the batteries in the low-voltage power supply systems is checked to perform charging state balancing among the batteries, thereby enhancing the stability of the redundant power network.

Hereinafter, an apparatus and a method for managing power for a vehicle according to an embodiment of the present disclosure will be described with reference to the accompanying drawings.

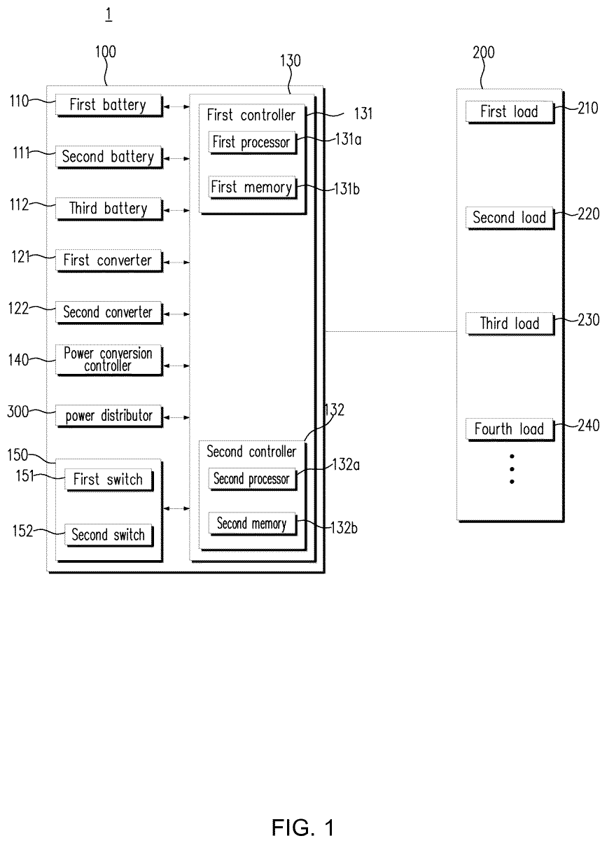

FIG. 1 is a block diagram illustrating an apparatus for managing power for a vehicle and load control according to an embodiment of the present disclosure.

Referring to FIG. 1, a power supply device 100 may be mounted to a vehicle 1 to supply or block power to a load 200 mounted in the vehicle 1. Here, a vehicle 1 represents an electrified vehicle such as an electric vehicle (EV), a hybrid electric vehicle (HEV), or a plug-in hybrid electric vehicle (PHEV).

The power supply device 100 may include a first battery 110, a second battery 111, a third battery 112, a first converter 121, a second converter 122, a first controller 131, a second controller 132, a power conversion controller 140, a power distributor 300, a first switch 151, and a second switch 152.

The first battery 110 may be provided in the vehicle 1 to supply power to a motor that generates driving force of the vehicle 1. For example, the first battery 110 may be a high-voltage battery and include an auxiliary battery. Also, the first battery 110 may include a high-voltage junction box for voltage distribution. The first battery 110 may be connected to the first converter 121 and the second converter 122. Here, a feature of being “connected” may represent a state capable of supplying a voltage as one end of the first battery 110 is electrically connected to one end of the converter.

The second battery 111 and the third battery 112 may store power supplied from the first battery 110 and supply the stored power to a first load 210 and a second load 220, respectively, in case of emergency.

The first converter 121 and the second converter 122 may be electrically connected to the first battery 110 to step down a voltage supplied from the first battery 110.

The first converter 121 may include a high-voltage terminal electrically connected to the first battery 110 and a low-voltage terminal that steps down and outputs the voltage supplied from the first battery 110. For example, the first converter 121 may have the high-voltage terminal connected to the first battery 110 and the low-voltage terminal connected to the first controller 131 to step down the high voltage input from the first battery 110, thereby outputting the voltage as a first voltage to the first controller 131.

The second converter 122 may include a high-voltage terminal electrically connected to the first battery 110 and a low-voltage terminal that steps down and outputs the voltage supplied from the first battery 110. For example, the second converter 122 may comprise the high-voltage terminal connected to the first battery 110 and the low-voltage terminal connected to the second controller 132 to step down the high voltage input from the first battery 110, thereby outputting the voltage as a second voltage to the first controller 131. The second voltage is less in magnitude than the first voltage. For example, the first voltage may be 24V, and the second voltage may be 12V.

The first converter 121 and the second converter 122 may be realized with a structure in which a half/full bridge converter and a rectifier are connected. However, the embodiment of the present disclosure is not limited thereto. For example, a structure of a typical converter and a structure of a converter to be developed may be applied.

Each of the first controller 131 and the second controller 132 may include at least one processor 131a and 132a and a memory 131b and 132b.

For example, the first controller 131 and the second controller 132 may include an electronic controller (ECU), a micro controller unit (MCU), or other subordinate controllers, which are mounted to the vehicle 1. The processor may be a central processing unit (CPU) or at least one dedicated processor that performs an operation and/or a method of a device according to an embodiment of the present disclosure.

A first processor 131a of the first controller 131 may process a signal received from the first converter 121. Accordingly, the first processor 131a of the first controller 131 may determine a failure such as an output limitation or a short circuit of the first converter 121 based on a feature of processing the signal received from the first converter 121. The first processor 131a of the first controller 131 may generate a signal that controls components of the power supply device 100 in response to a feature of determining the failure of the first converter 121. For example, the first processor 131a of the first controller 131 may generate a control signal that turns the first converter 121 on or off or a control signal that turns the first switch 151 on or off.

Also, the first processor 131a of the first controller 131 may check a state of charge (SOC) of the second battery 111 to determine whether charging is required. The first processor 131a may request charging to the power conversion controller 140 when the SOC of the second battery 111 is equal to or less than a preset remained quantity by checking an operation state of an autonomous driving load through CAN communication.

A second processor 132a of the second controller 132 may process a signal received from the second converter 122. Accordingly, the second processor 132a of the second controller 132 may determine a failure such as an output limitation or a short circuit of the second converter 122 based on a feature of processing the signal received from the second converter 122. The second processor 132a of the second controller 132 may generate a signal that controls the components of the power supply device 100 in response to a feature of determining the failure of the second converter 122. For example, the second processor 132a of the second controller 132 may generate a control signal that turns the second converter 122 on or off or a control signal that turns the second switch 152 on or off.

Also, the second processor 132a of the second controller 132 may check a SOC of the third battery 112 to determine whether charging is required. The second processor 132a may request charging to the power conversion controller 140 when the SOC of the third battery 112 is equal to or less than a preset remained quantity by checking an operation state of an autonomous driving load through the CAN communication.

Both the first processor 131a and the second processor 132a may execute a program command stored in respective memories 131b and 132b. Each of the memory 131b of the first controller and the memory 132b of the second controller may include a volatile storage medium and/or a non-volatile storage medium. For example, the memory may include a read-only memory (ROM) and/or a random access memory (RAM). Each of the memory 131b of the first controller and the memory 132b of the second controller may store data such as a command or program executed by the processors. For example, the memory 131b of the first controller 131 may contain a command that turns an operation of the first converter 121 on or off and a command that turns the first switch 151 on or off, and the memory 132b of the second controller 132 may contain a command that turns an operation of the second converter 122 on or off and a command that turns the second switch 152 on or off. Also, the memory may also contain a battery management program that monitors the SOC of each of the second battery 111 and the third battery 112 and executes a charging function based on a preset condition. However, the embodiment of the present disclosure is not limited thereto. For example, the memory may contain a command on an operation to be described below, and the processor may execute programs related to the operations described above and operations to be described below. Also, the memory may store at least one data generated by execution of the processor.

The power conversion controller 140 may manage redundancy power. The power conversion controller 140 may convert a first voltage received from the first controller 131 into a second voltage and output the converted second voltage to the second controller 132. Also, the power conversion controller 140 may convert the second voltage received from the second controller 132 into the first voltage and output the converted first voltage to the first controller 131. The power conversion controller 140 may operate in a boost mode and a buck mode to perform voltage conversion and transmission therebetween even when the first voltage and the second voltage have different levels. The power conversion controller 140 may operate in the boost mode to step up a voltage and operate in the buck mode to step down a voltage. The power conversion controller 140 may include a converter for converting the first voltage into the second voltage and a converter for converting the second voltage into the first voltage. The power conversion controller 140 may be realized with a structure in which a half/full bridge converter and a rectifier are connected. However, the embodiment of the present disclosure is not limited thereto. For example, a structure of a typical converter and a structure of a converted to be developed in the future may be applied.

The first switch 151 may turn on or off a connection between the first controller 131 and the first load 210.

The first switch 151 may be turned on or off according to a command of the first controller 131.

For example, the first switch 151 may be turned on in a normal power state to supply power to the first load 210 and turned off in an abnormal power state to block the power to the first load 210.

The second switch 152 may turn on or off a connection between the second controller 132 and the second load 220. The second switch 152 may be turned on or off according to a command of the second controller 132.

For example, the second switch 152 may be turned on in the normal power state to supply power to the second load 220 and turned off in the abnormal power state to block the power to the second load 220.

The power distributor 300 may supply power output from the first controller 131 and the second controller 132 to the respective loads.

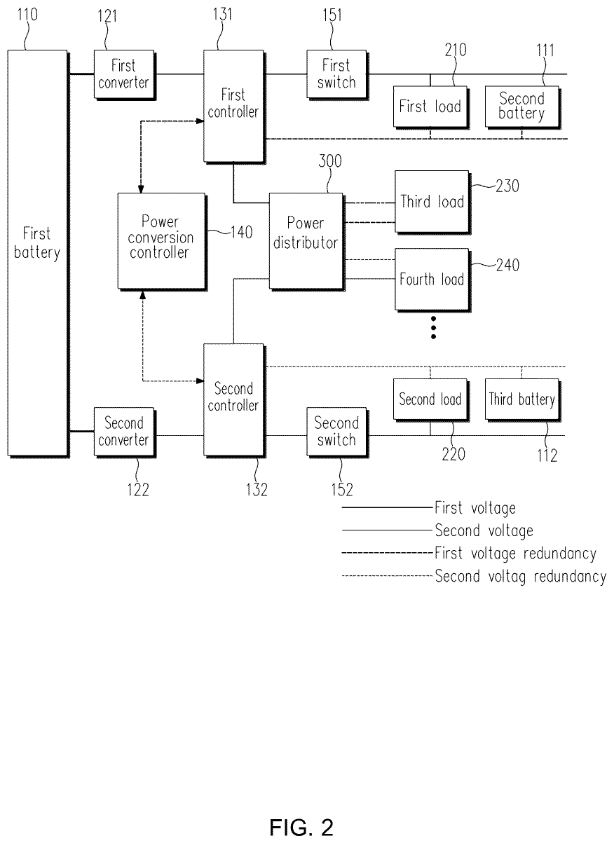

FIG. 2 is a schematic diagram illustrating a power connection state of the apparatus for managing power for a vehicle according to an embodiment of the present specification.

Referring to FIG. 2, the power supply device 100 may include a first battery 110 that supplies a high voltage, a first voltage system 10 that operates based on a first voltage bucked from the high voltage of the first battery 110, and a second voltage system 20 that operates based on a second voltage bucked to be less than the first voltage.

Referring to FIG. 2, a thick solid line represents the first voltage supplied to the first load 210 in the normal power state, a thin solid line represents the second voltage supplied to the second load 220 in the normal power state, a thick dashed line represents a first voltage redundancy when the first converter 121 is failed, and a thin dashed line represents a second voltage redundancy when the second converter 122 is failed.

In case of the normal power state of the first voltage system 10, the first controller 131 may control the first switch 151 to be turned on to supply the first voltage output from the first converter 121 to the first load 210 and the second battery 111. The second battery 111 may supply the first voltage to the first load 210 when the first converter 121 is failed or a short circuit occurs between the first converter 121 and the first controller 131.

The first controller 131 may supply the first voltage to the power conversion controller 140 for stability of power supply. The power conversion controller 140 may convert the first voltage supplied by the first controller 131 into a second voltage and output the converted second voltage to the second controller 132. As the power conversion controller 140 converts the first voltage into the second voltage and continuously supplies the converted second voltage to the second controller 132, the second controller 132 may stably supply power to the second load 220 even when the second converter 122 is failed.

The first controller 131 according to an embodiment of the present disclosure may check the SOC of the second battery 111 before and after the autonomous driving operation and request charging power supply to the power conversion controller 140. The first controller 131 may calculate an amount of the autonomous driving load required for the vehicle driving when power is supplied to the first load 210 due to the autonomous driving and request the charging power supply to the power conversion controller 140 to charge the second battery 111 when the SOC of the second battery 111 is equal to or less than a reference value. Also, after the autonomous driving operation, the first controller 131 may perform the SOC balancing mode that balances the SOC of each of the second battery 111 and the third battery 112 in the state of preparing to park. In the SOC balancing mode, the first controller 131 may balance the SOC of the second battery 111 and the third battery 112 in conjunction with the power conversion controller 140.

When the second voltage system 20 is in the normal power state, the second controller 132 may control the second switch 152 to be turned on to supply the second voltage output from the second converter 122 to the second load 220 and the third battery 112. The third battery 112 may supply the second voltage to the second load 220 when the second converter 122 is failed or when a short circuit occurs between the second converter 122 and the second controller 132.

The second controller 132 may supply the second voltage to the power conversion controller 140 for the stability of the power supply. The power conversion controller 140 may convert the second voltage supplied from the second controller 132 into the first voltage and output the converted first voltage to the first controller 131. As the power conversion controller 140 converts the second voltage into the first voltage and continuously supplies the converted first voltage to the first controller 131, the first controller 131 may stably supply power to the first load 210 even when the first converter 121 is failed.

The second controller 132 according to an embodiment of the present disclosure may check the SOC of the third battery 112 before and after the autonomous driving operation and request charging power supply to the power conversion controller 140. When the second controller 132 supplies power to the second load 220 according to the autonomous driving, the second controller 132 may calculate the amount of the autonomous driving load required for vehicle driving and request the charging power supply to the power conversion controller 140 to charge the third battery 112 when the SOC of the second battery 111 is equal to or less than a reference value. Also, after the autonomous driving operation, the second controller 132 may perform the SOC balancing mode that balances the SOC of each of the second battery 111 and the third battery 112 in the state of preparing to park. In the SOC balancing mode, the second controller 132 may balance the SOC of the second battery 111 and the third battery 112 in conjunction with the power conversion controller 140.

As described above, the apparatus for managing power for a vehicle according to an embodiment of the present disclosure may secure redundancy power when abnormality occurs by charging the battery of the low-voltage power supply system in use with the power conversion controller 140 that manages the redundancy power during the autonomous driving operation. Also, the SOC of the batteries included in the low-voltage power supply system may be optimally maintained by performing the SOC balancing mode using the power conversion controller 140 before the autonomous driving operation is completed and the power is turned off. Accordingly, stability of a redundancy power network may be improved.

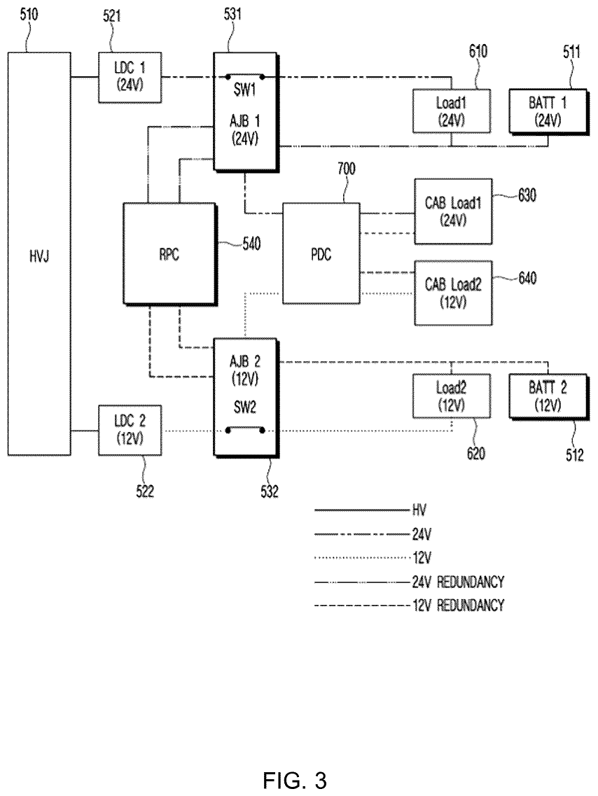

FIG. 3 is a schematic diagram illustrating the configuration of the apparatus for managing power for a vehicle according to an embodiment of the present disclosure. An embodiment of the apparatus for managing power for a vehicle in FIG. 3 specifically realizes respective blocks of the above-described FIGS. 1 and 2 and exemplifies a case of providing two low-voltage power supply systems that supplies 24V and 12V voltages as redundancy.

Referring to FIG. 3, the apparatus for managing power for a vehicle according to an embodiment of the present disclosure, which specifically realizes respective blocks of FIGS. 1 and 2, may include a high voltage junction box (HVJ) 510, BATT1 511, BATT2 512, a low voltage DC/DC converter (LDC) 1 521, a LDC 2 522, an active junction box (AJB) 1 531, an AJB 2 532, a redundancy power converter (RPC) 540, and a power-net domain controller (PDC) 700 to supply power to loads Load1, Load2, CAB Load1, and CAB Load2 of a vehicle.

The HVJ 510 that is a component for distributing a voltage of the high-voltage battery may perform a function similar to that of the first battery 110 (refer to FIG. 2). The HVJ 510 may supply a high voltage to the LDC1 521 and the LDC2 522.

The LDC1 521 and the LDC2 522 may perform functions similar to those of the first converter 121 (refer to FIG. 2) and the second converter 122 (refer to FIG. 2), respectively. The LDC1 521 may convert a high voltage received from the HVJ 510 into a voltage of 24V and output the converted voltage. The LDC2 522 may convert the high voltage received from HVJ 510 into a voltage of 12V and output the converted voltage.

The AJB1 531 performs a function similar to that of the first controller 131 (refer to FIG. 2) that contains the first switch 151 (refer to FIG. 2). The AJB1 531 may control a flow of 24V power in the power management device. The AJB1 531 may control the 24V power output from the LDC1 521 to be applied to the autonomous driving load Load1 610, the first battery BATT1 511, and the PDC 700, each of which requires the corresponding voltage. The switch SW1 contained in the AJB1 531 may include a back to back (B2B) switch that detects and blocks power fail. In this embodiment, a 24V B2B switch may be contained in AJB1 531. The AJB1 531 may process a signal received from the LDC1 521 to determine whether LDC1 521 is failed. The AJB1 531 may control the 24V power of the BATT1 511 to be applied to the autonomous driving load (Load1) 610 when the LDC1 521 is failed. The Load1 610, to which the 24V power is applied, may include a sensor for autonomous driving (e.g., a LiDAR, a radar, an ultrasonic sensor, and a cameras) and a processor that performs a calculation for autonomous driving.

The AJB2 532 performs a function similar to that of the first controller 132 (refer to FIG. 2) that contains the second switch 152 (refer to FIG. 2). The AJB2 532 may control a flow of 12V power in the power management device. The AJB2 532 may control the 12V power output from the LDC2 522 to be applied to the autonomous driving load (Load2) 620, the BATT2 512, and the PDC 700, each of which requires the corresponding voltage. The switch SW2 contained in the AJB2 532 may include a back to back (B2B) switch that detects and blocks power fail. In this embodiment, a 12V B2B switch may be contained in AJB2 532. The AJB2 532 may process a signal received from the LDC2 522 to determine whether the LDC2 522 is failed. When the LDC2 522 is failed, the AJB2 532 may control the 12V power of the BATT2 512 to be applied to the autonomous driving load (Load2) 620. The autonomous driving load (Load2) 620, to which the 12V power is applied, may include a sensor for autonomous driving (e.g., a LiDAR, a radar, an ultrasonic sensor, and a cameras) and a processor that performs a calculation for autonomous driving.

The RPC 540 may perform a function similar to that of the power conversion controller 140 (refer to FIG. 2). The RPC 540 may convert a redundancy voltage of the 24V power supply system controlled by the AJB1 531, and a redundancy voltage of the 12V power supply system controlled by the AJB2 532 in both directions. Here, the redundancy voltage may include a 24V redundancy voltage 24V REDUNDANCY that is input to and output from the 24V BATT1 511 and a 12V redundancy voltage 12V REDUNDANCY that is input to and output from the 12V BATT2 512.

The RPC 540 may operate in a boost mode to step up the 12V redundancy voltage 12V REDUNDANCY to the 24V redundancy voltage 24V REDUNDANCY. Also, the RPC 540 may operate in a buck mode to step down the 24V redundancy voltage 24V REDUNDANCY to the 12V redundancy voltage 12V REDUNDANCY. The RPC 540 may operate in the boost mode and the buck mode according to control of the AJB1 531 and the AJB2 532 to bidirectionally transfer the redundancy voltage of the 24V power supply system and the redundancy volage of the 12V power supply system.

When one of the 24V power supply system or the 12V power supply system is failed, e.g., when the LDC1 521 or the LDC2 522 is failed or a short circuit occurs in an output unit, the RPC 540 may supply power from a normally operating power supply system to a failed system. On the other hand, when both the 24V power supply system and the 12V power supply system operate normally, the RPC 540 may bidirectionally convert and supply the 12V power and the 24V power according to requests of the AJB1 531 and the AJB2 532. The RPC 540 may the voltage conversion mode and the output information through the CAN communication.

Since the AJB1 531 according to an embodiment of the present disclosure receives power from the 24V BATT1 511 and the 24V LDC1 521 in the 24V power supply system, the AJB1 531 may check a power consumption state of the 24V autonomous driving load (Load1) 610 through the CAN communication. Also, the AJB1 531 may check the SOC of the 24V BATT1 511. Thus, when the SOC of the 24V BATT1 511 is equal to or less than a reference value, e.g., 80%, the AJB1 531 may use the boost mode of the RPC 540 to charge the 24V BATT1 511 in advance during the autonomous driving.

Also, since the AJB2 532 receives power from the 12V BATT2 512 and the 12V LDC2 522 in the 12V power supply system, the AJB2 532 may check a power consumption state of the 12V autonomous driving load (Load2) 620 through the CAN communication and the SOC of the BATT2 512. Thus, when the SOC of the 12V BATT2 512 is equal to or less than a reference value, e.g., 80%, the AJB2 532 may use the buck mode of the RPC 540 to charge the 12V BATT2 512 in advance during autonomous driving.

As described above, the AJB1 531 and the AJB2 532 may check the SOCs of the 24V BATT1 511 and the 12V BATT2 512, respectively, and charge the batteries during the autonomous driving to secure a longer driving range in a redundancy power supply situation.

Also, after the autonomous driving is completed and before turning off an engine, the AJB1 531 and the AJB2 532 may compare the SOCs of the 24V BATT1 511 and the 12V BATT2 512 and balance a SOC level therebetween. The AJB1 531 and the AJB2 532 may check their respective autonomous driving loads Load and Load2, calculate a mutual charging range, and then balance the SOC levels between the 24V BATT1 511 and the 12V BATT2 512 to an optimized SOC level for each battery to prevent battery discharge after being parked.

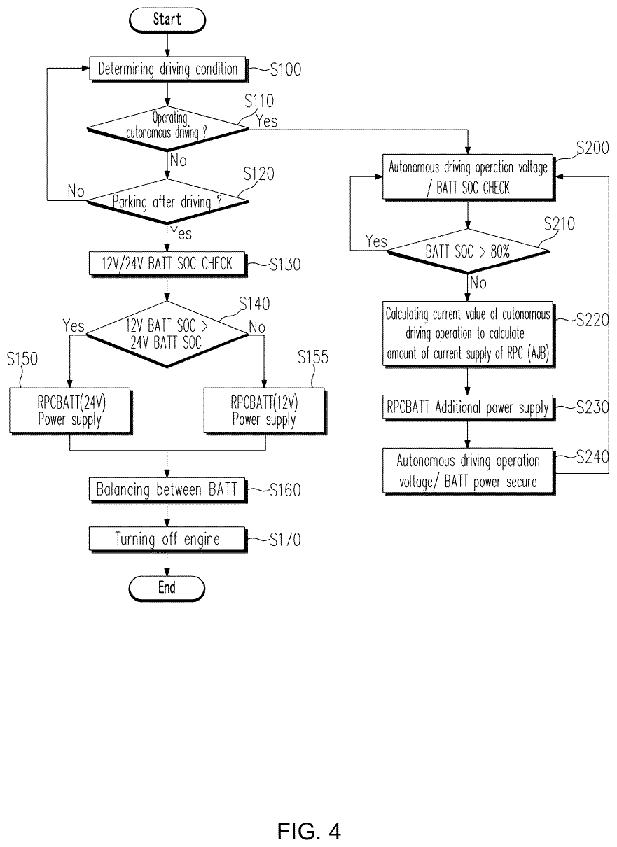

FIG. 4 is a flowchart illustrating a method for managing power for a vehicle according to an embodiment of the present disclosure.

Referring to FIG. 4, each of the AJB1 531 and the AJB2 532 may determine a current driving condition, in operation S100.

The AJB1 531 and the AJB2 532 check whether the current driving condition is autonomous driving in step S110.

When it is determined that a vehicle is autonomously driving, the AJB1 531 and the AJB2 532 check an autonomous driving operating voltage and a SOC of the corresponding battery in step S200. Since the AJB1 531 receives power from the 24V BATT1 511 and the 24V LDC1 521 in the 24V power supply system, the AJB1 531 may check a power consumption state of the 24V autonomous driving load (Load1) 610 and a SOC of the 24V BATT1 511. Also, since the AJB2 532 receives power from the 12V BATT2 512 and the 12V LDC2 522 in the 12V power supply system, the AJB2 532 may check a power consumption status of the 12V autonomous driving load (Load2) 620 and a SOC of BATT2 512.

The AJB1 531 and the AJB2 532 determine whether the SOC is greater than a reference value, e.g., 80% in step S210. The AJB1 531 may check the SOC of the 24V BATT1 511, and the AJB2 532 may check the SOC of the 12V BATT2 512. When the SOC is greater than 80%, the AJB1 531 and the AJB2 532 continuously check the SOC according to the step S200.

When the SOC is equal to or less than 80%, the corresponding AJB calculates a power consumption state of the autonomous driving load, e.g., a current value required for the autonomous driving operation to calculate an amount of current to be supplied from the RPC 540 in step S220.

The AJB requests the calculated amount of the current to be supplied to the RPC 540 to receive additional power in step S230.

The AJB charges the battery (BATT) with the current supplied from the RPC 540 to secure battery power in step S240. When charging is complete, the AJB continuously checks the SOC again according to the step S200.

When it is determined in the step S110 that the vehicle is not in the autonomous driving state, it is determined whether the vehicle is parked after driving in step S120.

When the vehicle is in a parked state after driving, the AJB1 531 and the AJB2 532 check respective SOCs before turning off the engine in step S140. The AJB1 531 may check the SOC of the 24V BATT1 511, and the AJB2 532 may check the SOC of the 12V BATT2 512.

Thereafter, it is determined that which of the two batteries has a higher SOC. For example, it is determined whether the SOC of the 12V BATT1 512 is greater than the SOC of the 24V BATT1 511 in step S140.

When the SOC of the 12V BATT1 512 is greater, the RPC 540 supplies power from the 12V BATT1 512 to the 24V BATT1 511 according to a request of the AJB1 531 and the AJB2 532 in step S150. Here, the RPC 540 operates in the boost mode to step up the 12V power to the 24V power and supply the boosted power as charging power to the 24V BATT1 511.

When the SOC of the 12V BATT1 512 is less, the RPC 540 supplies power from the 24V BATT1 511 to the 12V BATT1 512 according to a request of the AJB1 531 and the AJB2 532 in step S155. Here, the RPC 540 operates in the buck mode to step down the 24V power to 12V power and supply the bucked power as charging power of the 12V BATT2 512.

Through the above-described processes, the AJB1 531 and the AJB2 532 may balance the SOC levels between the 24V BATT1 511 and the 12V BATT2 512 in step S160 and then the engine may be turned off when the balancing is complete in step S170.

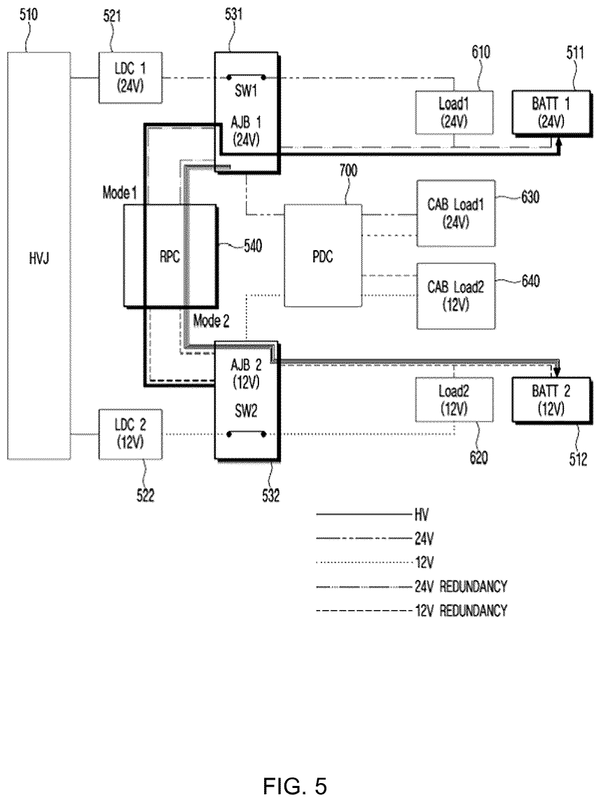

FIG. 5 is a schematic view illustrating a flow of power in an apparatus for managing power for a vehicle according to a first embodiment of the present disclosure and a power supply state of the RPC 540 during autonomous driving.

In case of the autonomous driving, the AJB1 531 of the 24V power supply system may check a power consumption state of the 24V autonomous load (Load1) 610 and the SOC of the 24V BATT1 511. When the AJB1 531 determines that the SOC of the 24V BATT1 511 is equal to or less than a reference value, the AJB1 531 may request a charging power supply. Accordingly, the RPC 540 operates in a boost mode Mode1 to step up the 12V power of the AJB2 532 to the 24V power, thereby supplying the boosted power as charging power of the 24V BATT1 511.

In the situation of autonomous driving, the AJB2 532 of the 12V power supply system may check a power consumption state of the 12V autonomous load (Load2) 620 and the SOC of the 12V BATT1 512. When the AJB2 532 determines that the SOC of the 12V BATT1 512 is equal to or less than a reference value, the AJB1 531 may request a charging power supply. Thus, the RPC 540 may operate in a buck mode Mode2 to step down the 24V power of the AJB1 531 to the 12V power and supplying the bucked power as charging power of the 12V BATT1 512.

As described above, according to the first embodiment of the present disclosure, the RPC 540 may charge both the 24V BATT1 511 and the 12V BATT1 512 in the autonomous driving in which the 24V power applied from LDC1 521 is supplied to the 24V autonomous load (Load1) 610, and the 12V power applied from LDC2 522 is supplied to the 12V autonomous load (Load2) 620. That is, even when the LDC1 521 and the LDC2 522 operate normally, the RPC 540 that controls a flow of redundancy power may operate in the boost mode Mode1 and the buck mode Mode2 to charge the 24V BATT1 511 and the 12V BATT1 512, thereby stably securing the redundancy power.

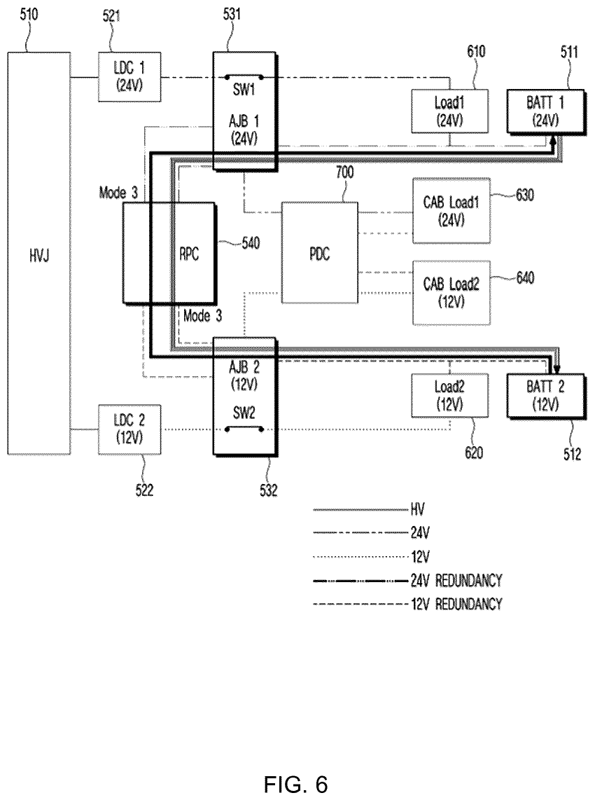

FIG. 6 is a schematic view illustrating a flow of power in an apparatus for managing power for a vehicle according to a second embodiment of the present disclosure and a power supply state of the RPC 540 when a vehicle is ready to park after the autonomous driving is finished.

When the vehicle is in a parked state after the autonomous driving is finished, a SOC balancing may be performed before turning off an engine. The AJB1 531 and the AJB2 532 check the SOCs of the 24V BATT1 511 and the 12V BATT1 512, respectively, and determine which battery has a higher SOC.

When the SOC of the 12V BATT1 512 is greater, the RPC 540 may operate in a SOC balancing mode Mode3 to supply power from the 12V BATT1 512 as charging power of the 24V BATT1 511. Here, the RPC 540 may operate in the boost mode to step up the 12V power to the 24V power and supply the boosted power as charging power to the 24V BATT1 511.

When the SOC of 12V BATT1 512 is less, the RPC 540 may operate in the SOC balancing mode Mode3 to supply power from 24V BATT1 511 as charging power of 12V BATT1 512. Here, the RPC 540 may operate in the buck mode to step down the 24V power to the 12V power and supply the bucked power as charging power of the 12V BATT2 512.

When the SOC balancing between the 24V BATT1 511 and the 12V BATT2 512 is complete, the engine may be turned off. Here, a balancing level between the 24V BATT1 511 and the 12V BATT2 512 may be determined by the AJB1 531 and the AJB2 532. The AJB1 531 and the AJB2 532 may determine an SOC level that allows a battery maintenance time to be maximized based on a pre-stored dark current value for each load as the balancing level.

As described above, according to the second embodiment of the present disclosure, after the autonomous driving is completed, the SOC level of the 24V BATT1 511 and the 12V BATT1 512 may be balanced through the RPC 540. Accordingly, the battery maintenance time may be maximized even when the battery is discharged by the dark current after the engine is turned off.

The embodiment of the present disclosure have the following effects:

The apparatus and the method for managing the power for the vehicle according to the embodiment of the present disclosure have the effect of improving the stability of the redundancy power net.

The apparatus and the method for managing the power for the vehicle according to the embodiment of the present disclosure may check the SOC of the battery of each low-voltage power supply system during the autonomous driving operation to charge the power, thereby providing the longer driving distance through the stable power supply based on the improved SOC when the redundancy power supply situation occurs.

Also, the apparatus and the method for managing the power for the vehicle according to the embodiment of the present disclosure may perform the balancing of the charge states between the batteries by checking the SOCs of the batteries of the low-voltage power supply system after the autonomous driving is finished to prepare the reduction of the SOC due to the battery discharge after being parked.

Although the embodiments of the present disclosure have been described, it is understood that the present disclosure should not be limited to these embodiments but various changes and modifications can be made by one ordinary skilled in the art within the spirit and scope of the present disclosure as hereinafter claimed.

Thus, the embodiment of the present disclosure is to be considered illustrative, and not restrictive, and the technical spirit of the present disclosure is not limited to the foregoing embodiment. Thus, the above-disclosed embodiments are to be considered illustrative and not restrictive. Therefore, the scope of the invention is defined not by the detailed description of the invention but by the appended claims, and all differences within the scope will be construed as being included in the present disclosure.

What is claimed is:

1. An apparatus for managing power for a vehicle, the apparatus comprising:
a first power supplier configured to supply power;
a first voltage system configured to step down a voltage output from the first power supplier into a first voltage to supply the first voltage to one or more first loads, the first voltage system comprising a first battery configured to supply a first redundancy power to the one or more first loads;
a second voltage system configured to step down the voltage output from the first power supplier into a second voltage, which is less in magnitude than the first voltage, to supply the second voltage to one or more second loads, the second voltage system comprising a second battery configured to supply a second redundancy power to the one or more second loads; and
a power conversion controller configured to convert the first voltage of the first voltage system into the second voltage and convert the second voltage of the second voltage system into the first voltage,
wherein the first battery and the second battery are charged by receiving power from the power conversion controller while the vehicle is in autonomous driving.

2. The apparatus of claim 1, wherein the first voltage system further comprises:
a first converter configured to step down the voltage output from the first power supplier into the first voltage; and
a first controller configured to supply the first voltage to the one or more first loads and charge the first battery by a charging voltage of a first voltage level from the power conversion controller when a state of charge (SOC) of the first battery is equal to or less than a reference value while the first voltage being supplied to the one or more first loads.

3. The apparatus of claim 2, wherein the first controller is further configured to control the first battery to supply the first redundancy power to the one or more first loads when the first converter is in a failed state.

4. The apparatus of claim 2, wherein the first controller is further configured to supply the first voltage to the power conversion controller according to a request from the second voltage system while the first voltage being supplied to the one or more first loads.

5. The apparatus of claim 1, wherein the second voltage system further comprises:
a second converter configured to step down the voltage output from the first power supplier into the second voltage; and
a second controller configured to supply the second voltage to the one or more second loads and charge the second battery by a charging voltage of a second voltage level from the power conversion controller when a SOC of the second battery is equal to or less than a reference value while the second voltage being supplied to the one or more second loads.

6. The apparatus of claim 5, wherein the second controller is further configured to control the second battery to supply the second redundancy power to the one or more second loads when the second converter is in a failed state.

7. The apparatus of claim 5, wherein the second controller is further configured to supply the second voltage to the power conversion controller according to a request from the first voltage system while the second voltage being supplied to the second load.

8. The apparatus of claim 1, wherein the one or more first loads or the one or more second loads comprise at least one autonomous driving load.

9. The apparatus of claim 1, wherein the first voltage system or the second voltage system is further configured to balance SOC levels of the first battery and the second battery after autonomous driving.

10. The apparatus of claim 9, wherein the first voltage system further comprises:
a first converter configured to step down the voltage output from the first power supplier into the first voltage; and
a first controller configured to supply, during the autonomous driving, the first voltage to the one or more first loads and charge, after the autonomous driving, the first battery by a charging voltage of a first voltage level from the power conversion controller when the SOC level of the second battery is greater than the SOC level of the first battery.

11. The apparatus of claim 10, wherein the first controller is further configured to supply power from the first battery to the power conversion controller when the SOC level of the second battery is less than the SOC level of the first battery.

12. The apparatus of claim 9, wherein the second voltage system further comprises:
a second converter configured to step down the voltage output from the first power supplier into the second voltage; and
a second controller configured to supply, during the autonomous driving, the second voltage to the one or more second loads and charge, after the autonomous driving, the second battery by a charging voltage of a second voltage level from the power conversion controller when the SOC level of the first battery is greater than the SOC level of the second battery.

13. The apparatus of claim 12, wherein the second controller is further configured to supply power from the second battery to the power conversion controller when the SOC level of the first battery is less than the SOC level of the second battery.

14. A method of controlling an apparatus for managing power for a vehicle, the method comprising:
preparing a first voltage system configured to step down a voltage output from the first power supplier into a first voltage to supply the first voltage to one or more first loads, the first voltage system comprising a first battery configured to supply a first redundancy power to the one or more first loads;
preparing a second voltage system configured to step down the voltage output from the first power supplier into a second voltage, which is less in magnitude than the first voltage, to supply the second voltage to one or more second loads, the second voltage system comprising a second battery configured to supply a second redundancy power to the one or more second loads;
checking a state of charge (SOC) of the first battery and a SOC of the second battery during autonomous driving;
charging the first battery by a charging voltage from the second voltage system when the SOC of the first battery is equal to or less than a first reference value; and
charging the second battery by a charging voltage from the first voltage system when the SOC of the second battery is equal to or less than a second reference value.

15. The method of claim 14, wherein the first voltage system comprises:
a first converter configured to step down the voltage output from the first power supplier into the first voltage; and
a first controller configured to supply the first voltage to the one or more first loads and charge the first battery by a charging voltage of a first voltage level from the power conversion controller when the SOC of the first battery is equal to or less than the first reference value.

16. The method of claim 14, wherein the second voltage system comprises:
a second converter configured to step down the voltage output from the first power supplier into the second voltage; and
a second controller configured to supply the second voltage to the one or more second loads and charge the second battery by a charging voltage of a second voltage level from the power conversion controller when the SOC of the second battery is equal to or less than the second reference value while the second voltage being supplied to the second load.

17. The method of claim 14, further comprising balancing SOC levels of the first battery and the second battery after autonomous driving.

18. The method of claim 17, wherein the first voltage system further comprises:
a first converter configured to step down the voltage output from the first power supplier into the first voltage; and
a first controller configured to supply, during the autonomous driving, the first voltage to the one or more first loads and charge, after the autonomous driving, the first battery by a charging voltage of a first voltage level from the first voltage system when the SOC of the second battery is greater than the SOC of the first battery and supply power of the first battery to the second voltage system when the SOC of the second battery is less than the SOC of the first battery.

19. The method of claim 17, wherein the second voltage system further comprises:
a second converter configured to step down the voltage output from the first power supplier into the second voltage; and
a second controller configured to supply, during autonomous driving, the second voltage to the one or more second loads and charge, after the autonomous driving, the second battery by a charging voltage of a second voltage level from the first voltage system when the SOC of the first battery is greater than the SOC of the second battery and supply power of the second battery to the first voltage system when the SOC of the first battery is less than the SOC of the second battery.

20. A non-transitory recording medium storing instructions which are executed by one or more processors, wherein the instructions, when executed by the one or more processors, cause the one or more processors to:
prepare a first voltage system configured to step down a voltage output from the first power supplier into a first voltage to supply the first voltage to one or more first loads, the first voltage system comprising a first battery configured to supply a first redundancy power to the one or more first loads;
prepare a second voltage system configured to step down the voltage output from the first power supplier into a second voltage, which is less in magnitude than the first voltage, to supply the second voltage to one or more second loads, the second voltage system comprising a second battery configured to supply a second redundancy power to the one or more second loads;
check a state of charge (SOC) of the first battery and a SOC of the second battery during autonomous driving;
charge the first battery by a charging voltage from the second voltage system when the SOC of the first battery is equal to or less than a first reference value; and
charge the second battery by a charging voltage from the first voltage system when the SOC of the second battery is equal to or less than a second reference value.
